(19) United States
(12) Patent Application Publication
(10) Pub. No.: US 2026/0000563 A1
(43) Pub. Date: Jan. 1, 2026

(54) HUMAN INVERSION AND ROTATIONAL EXERCISE

(71) Applicant: UNCHAINED LLC, Roseville, CA (US)

(72) Inventor: Benjamin William Farley, Roseville, CA (US)

(73) Assignee: UNCHAINED LLC, Roseville, CA (US)

(21) Appl. No.: 19/251,669

(22) Filed: Jun. 26, 2025

Related U.S. Application Data
(60) Provisional application No. 63/664,503, filed on Jun. 26, 2024.

(51) Int. Cl. A61H 1/02

(52) U.S. Cl. CPC A61H 1/0229; A61H 2201/1642; A61H 2203/0493

(57) ABSTRACT

Disclosed is an apparatus for inversion exercise comprising a hang element coupled to a turntable, which is attached to a suspension framework. In embodiments, the hang element is configured to rotate with respect to the suspension framework, permitting a user to spin while hanging in either an inverted or upright position. In certain embodiments, the suspension framework may comprise a geodesic dome structure.

### CROSS-REFERENCE TO RELATED APPLICATIONS

The present invention claims priority under 35 USC 119(e) to commonly-owned U.S. Application No. 63/664,503, by Farley filed Jun. 26, 2024, entitled APPARATUS FOR INVERSION AND ROTATIONAL EXERCISE the contents of which being hereby incorporated by reference in its entirety.

### FIELD OF THE INVENTION

The invention relates generally to health and fitness, and more specifically, to human inversion and rotational exercise.

### BACKGROUND

The problem of back and neck pain from excessive sitting and poor posture, is all too common. Furthermore, flexibility, mental fatigue, weak core strength and stress are agitators to these pains, and many other problems. Traditional medications, such as anti-inflammatories, muscle relaxers and others, can also have side effects and foster addiction.

Inversion exercise is a non-medical remedy found to have therapeutic effects for the treatment of such problems, as well as other physiological benefits. A conventional inversion table allows a user to strap up to the table while standing vertically, and then to rotate the table on a hinge for user inversions. A traction machine can have similar results from a horizontal position with motors decompressing the spine in place of gravity. Problematically, the inversion or traction alone, focuses primarily on limited aspects of the body, and thus, has limited results.

Therefore, what is needed is a robust technique for human inversion and rotational exercise, that stimulates a mind/body connection with multi-modal physical activity.

### SUMMARY

To meet the above-described needs, apparatus and methods for human inversion and rotational exercise, are set forth herein.

In one embodiment, a geodesic dome framework having a plurality of interconnected members to provide structural support for vertical and rotational forces derived from an inverted human that is under rotation. A mounting bracket is attached to members of a top portion of the geodesic dome for vertical support. A turntable is attached to a plate of the mounting bracket configured for rotation along a central vertical axis while remaining fixed along a horizontal axis.

In another embodiment, a hang element is attached to the turntable and configured for attaching to clips of gravity boots for vertically suspending the gravity boots in an upside down position with soles of the gravity boots facing the top of the geodesic dome directly supporting the inverted human to hang upside down from the geodesic dome while dynamically rotating about the central vertical axis. Many other embodiments are possible.

Advantageously, the health and fitness of humans can be improved.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a front cross-section diagram illustrating aspects of an apparatus for human inversion and exercise, according to some embodiments.

FIG. 2 is a perspective diagram of a dome structure from the apparatus of FIG. 1, according to an embodiment.

FIG. 3 is a perspective diagram illustrating details of a joint of the dome structure from the dome of FIG. 2 (i.e., cut 2-2), according to an embodiment.

FIG. 4 is a perspective diagram showing a side elevation view of a hang bar assembly of the dome structure of FIG. 2 (i.e., cut 4-4), according to an embodiment.

FIG. 5 is a detail cross-view of the hang bar assembly of FIG. 4 (i.e., cut 5-5), according to an embodiment.

FIG. 6 is a flow diagram illustrating a method for flow chart illustrating a method for human inversion and exercise, according to an embodiment.

### DETAILED DESCRIPTION

The disclosed subject matter provide an apparatus and methods for a human to rotate his/her body while suspended. In certain embodiments, the user may rotate while suspended upside down, while in other embodiments, the user may rotate while positioned upright.

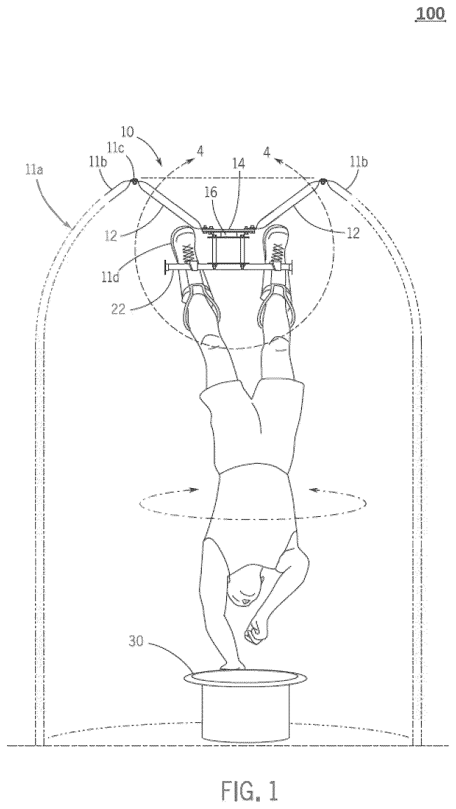

### I. Apparatus for Rotational Exercise (FIGS. 1-5)

In certain embodiments as depicted in FIGS. 1-5, apparatus 10 may comprise a hang bar 22 or other suspension element, coupled to a suspension framework 11a. In some embodiments, a user may hang upside down from the hang bar via inversion boots 11d, which are configured to securely attach to the hang bar. Hang bar 22 may be configured to rotate with respect to suspension framework 11a permitting the user to spin while in an upside-down position, as shown. In embodiments, a user may push off a manual rotation device 30 to achieve rotational motion. The apparatus may be provided as a kit to be assembled by the end user and used in commercial gyms, garages, backyards, temporary set-ups (e.g., a county fair) and the like. For example, the components of one embodiment break down for packing into a carrying case or compact storage.

In certain embodiments as best depicted in FIG. 1, apparatus 10 may comprise a turntable 16 coupled between suspension framework 11a and hang bar 22. Turntable 16 may be attached to suspension framework 11a via a mounting plate 14, which may be suspended from suspension framework 11a via struts 12. In embodiments as shown in FIGS. 1-3, struts 12 may couple to bars 11b of suspension framework 11a via connecting hardware 11c.

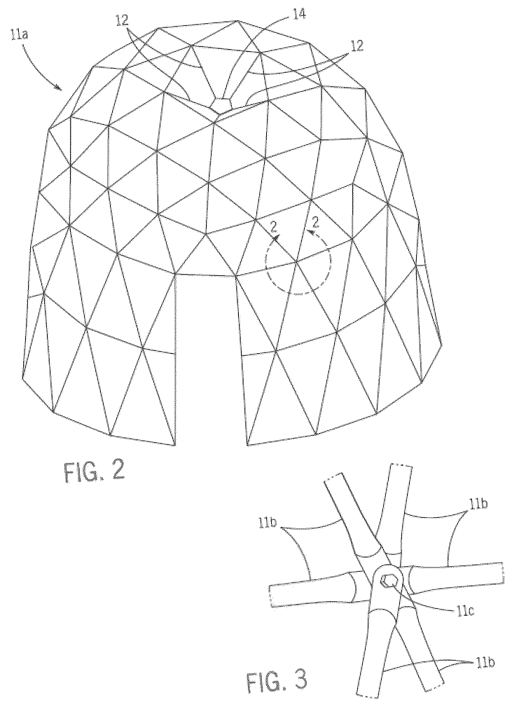

With specific reference to FIG. 2, suspension framework 11a assembled from a bar structure, and/or a network of bars made of steel or other sturdy material, that provides an elevated framework for suspending hang bar 22. In embodiments, suspension framework 11a may be supported on a surface, such as the ground, but is not limited to this option. Legs may also protrude into the ground for foundation support. FIG. 3 shows, without any limitations, an example joint between members of suspension framework 11a. Other joint configurations can be substituted. Members can be snapped into place at the joint, or the joint can provide folding points between connected members for easy set up and tear down. The suspension framework 11a is manufactured from steel, plastic, or any combination of appropriate materials.

In certain embodiments, suspension framework 11a may be a dome structure, such as a geodesic dome, wherein mounting plate 14 may have a pentagonal geometry that may be attached via five struts 12 at its corners. In some embodiments, the dome structure may be covered (e.g., with a tarp, black out cloth, porous mesh, or the like) to provide a user with privacy, and/or shield from the sun or cold weather, and the like. Moreover, the dome interior can be enhanced with strobe lights, infrared light, or other ayurvedic mechanisms for additional mental stimulation. Aromas and other gaseous stimulants can be vented into the dome and contained with a tarp, as an additional modality. An array of speakers can be attached to the frame for binaural beats and other auditory stimulations. Optionally, tactile stimulation can be added with a motor to vibrate the hang bar/boots, or by additional ranges of motion added to the vertical rotational axis. For example, an oscillation or movement of the axis around a circular pattern, similar to the pattern of dual rotation of Earth's poles. It shall be appreciated however, that various suspension framework structures may be provided in alternate embodiments.

A control system of one embodiment provides a remote control or voice command set up of multiple stimulants. A first configuration can be fast and vigorous while a second configuration can be gentle or meditative. A third configuration can automatically change configurations. In still other implementations, the control system can synchronize multiple modalities, such as adjusting rotational speed according to music beats or binaural parameters. Similarly, strobe lighting or coloring can correspond to music beats or aromas. A user can switch configurations during exercise to vary stimulations. The control system can be implemented with a control box having inputs and outputs to modalities managed by an operating system with a processor.

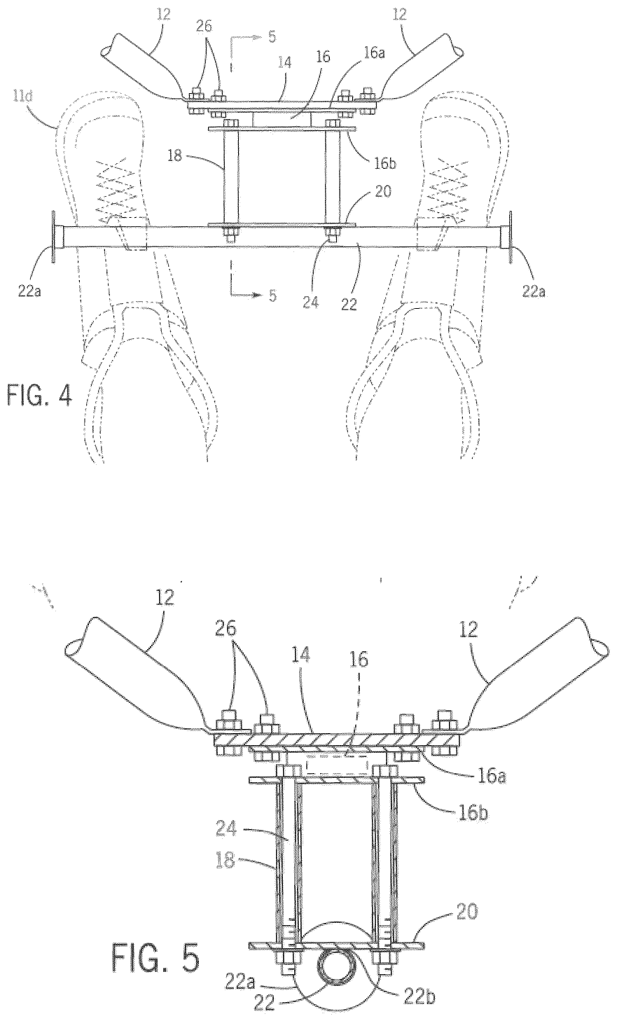

In certain embodiments, turntable 16 may be coupled to a turntable top mounting 16a and a turntable base mounting 16b, and may further be configured to rotate with respect to the top mounting 16a and/or base mounting 16b. As best depicted in FIGS. 4 and 5, turntable 16 is attached to mounting plate 14 via turntable top mounting 16a using attachment elements such as nuts and bolts 26 or welding. Turntable 16 is rigidly attached to the hang bar 22 via a hang bar mounting plate 20 that may be welded to the hang bar 22. Additionally, mounting plate 20 may be attached to plate 16b via long bolts and nuts 24 running through spacer bars 18 and plate 20, as shown. It shall be appreciated that other configurations for rotational mounting of hang bar 22 may be provided in alternate embodiments.

In embodiments, mounting plate 14 may be coupled to suspension framework 11a via a plurality of struts 12. In certain embodiments, struts 12 may have a “J” configuration, wherein each strut may be coupled at its bottom end to a corner of mounting plate 14 via attachment nuts and bolts 26, and at its top end to a bar 11b of framework 11a.

In certain embodiments, hang bar 22 may be configured to receive a hook portion of inversion boots 11d, gravity boots or other such footwear, to permit a user to hang upside down. In embodiments, hang bar 22 may comprise caps 22a, at its opposite ends, which may be attached via a weld 22b between each cap and the hang bar. In embodiments, caps 22a may prevent a user from accidentally slipping off the hang bar. It shall be appreciated that various mechanisms for attachment of a user to the hang bar may be used in alternate embodiments.

According to an exemplary embodiment, top mounting 16a and base mounting 16b may be rectangular plates, each about 4.5 inches wide, about 6.5 inches in length, and about 0.25 inches in thickness, and may be spaced about 1.19 inches to sandwich the turntable. Mounting of the turntable to the mounting plate allows the turntable to easily spin in 360-degree rotations. The hang bar, may be welded to the plate and bolted to the turntable using 5 inch spacers made of steel tubing with 0.5″×6″ bolts, lock washers and nuts. In some alternate embodiments, an electric rotation component, such as an electric turntable and/or steering wheel mounted to the floor may be provided to allow the user to perform inverted rotations.

Additionally, manual rotation device 30 is placed on a firm surface, and within reach of the suspended individual, such that said individual may push off rotation device 30 to create rotational momentum, for 360-degree rotation(s). Some embodiments have a motorized rotation device. Other embodiments include tactile stimulants as an additional modal stimulation.

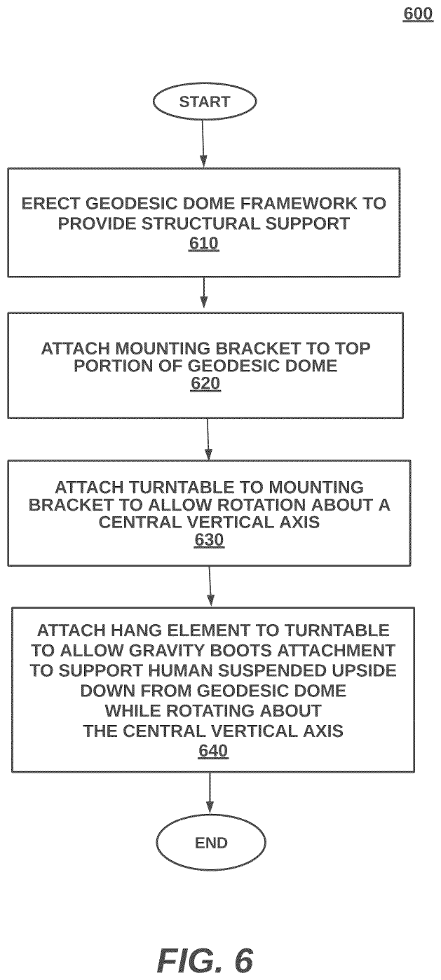

### II. Methods for Rotational Exercise (FIG. 6)

In operation, a user may hang, inverted (using gravity boots), or by gripping the bar with both hands in an upright position, and perform 360-degree rotations while suspended. In the inverted position, the user may use his/her hands to push off manual rotation device to rotate. In embodiments, the user may use his/her hands to “climb” up the dome structure, and to detach the inversion boots from the hang bar when done.

FIG. 6 is a flow diagram illustrating a method for flow chart illustrating a method 600 for human inversion and exercise, according to an embodiment.

At step 610, a geodesic dome framework is erected. The dome includes a plurality of interconnected members to provide structural support for vertical and rotational forces derived from an inverted human that is under rotation. Other implementations use different support structures.

At step 620, a mounting bracket is attached to members of a top portion of the geodesic dome for vertical support. At step 630, a turntable is attached to a plate of the mounting bracket configured for rotation along a central vertical axis while remaining fixed along a horizontal axis. At step 640, a hang element is attached to the turntable and configured for attaching to clips of gravity boots for vertically suspending the gravity boots in an upside down position with soles of the gravity boots facing the top of the geodesic dome directly supporting the inverted human to hang upside down from the geodesic dome while dynamically rotating about the central vertical axis.

At step 650, a human hangs upside down by climbing to a top portion the geodesic dome framework and hanging by hands while attaching clips of hanging boots to a hang bar of the structure, and then releasing hands to allow hanging boots to support the human hanging vertically upside down. The human can then use a block on the ground to initiate rotation, according to the turntable.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use.

The scope of the invention is defined by the following claims.

I claim:

1. An apparatus for human inversion with rotational exercise, comprising:
a geodesic dome framework having a plurality of interconnected members to provide structural support for vertical and rotational forces derived from an inverted human that is under rotation;
a mounting bracket attached to members of a top portion of the geodesic dome for vertical support;
a turntable attached to a plate of the mounting bracket configured for rotation along a central vertical axis while remaining fixed along a horizontal axis; and
a hang element attached to the turntable and configured for attaching to clips of gravity boots for vertically suspending the gravity boots in an upside-down position with soles of the gravity boots facing the top of the geodesic dome directly supporting the inverted human to hang upside down from the geodesic dome while dynamically rotating about the central vertical axis.

2. The apparatus of claim 1, further comprising:
a base structure resting on a floor of the geodesic dome and configured for manual rotation by the inverted human.

3. The apparatus of claim 1, further comprising:
a base structure resting on a floor of the geodesic dome and configured for motorized rotation of the inverted human.

4. The apparatus of claim 1, wherein the turntable is configured for motorized rotation of the inverted human.

5. The apparatus of claim 1, wherein the geodesic dome framework members are configured to allow the inverted human to change position from an upright position to an upside-down position.

6. The apparatus of claim 1, wherein the mounting structure comprises a set of J-struts attached to the top portion of the geodesic dome and the plate coupled to the J-struts in a suspended position.

7. The apparatus of claim 1, wherein the geodesic dome members comprise vertical leg members dispersed around the geodesic dome.

8. The apparatus of claim 1, wherein the turntable comprises a ball and socket mechanism that is configured to provide affixed rotation and also independently supports the inverted human.

9. The apparatus of claim 1, wherein the mounting bracket is detachable from the geodesic dome members and the geodesic dome is collapsible to flatten out.

10. The apparatus of claim 1, wherein gravity boots are put on by the inverted human while in an upright position.

11. The apparatus of claim 1, wherein the geodesic dome is self-supporting.

12. The apparatus of claim 1, wherein the turntable allows rotation along the central vertical axis, and at the same time, allows orbital rotation of the central vertical axis.

13. A method for human inversion with rotational exercise on an apparatus, comprising:
erecting a geodesic dome framework having a plurality of interconnected members to provide structural support for vertical and rotational forces derived from an inverted human that is under rotation;
attaching a mounting bracket to members of a top portion of the geodesic dome for vertical support;
attaching a turntable to a plate of the mounting bracket configured for rotation along a central vertical axis while remaining fixed along a horizontal axis; and
attaching a hang element to the turntable and configured for attaching to clips of gravity boots for vertically suspending the gravity boots in an upside-down position with soles of the gravity boots facing the top of the geodesic dome directly supporting the inverted human to hang upside down from the geodesic dome while dynamically rotating about the central vertical axis.
